(19) United States
(12) Patent Application Publication
(10) Pub. No.: US 2025/0133100 A1
(43) Pub. Date: Apr. 24, 2025

(54) SECURE REMOTE ADMINISTRATION WITH REAL-TIME ANOMALY DETECTION VIA AI

(71) Applicant: DELINEA INC., San Francisco, CA (US)

(72) Inventors: Dmitriy AYRAPETOV, San Jose, CA (US); Bob JANSSEN, Kralendijk (NL); Peter Gerardus JANSEN, Goirle (NL); Clifford VAN SLIMMING, Almere (NL); Noah HAIBACH, Frankfurt am Main (DE)

(21) Appl. No.: 18/921,770

(22) Filed: Oct. 21, 2024

Related U.S. Application Data
(60) Provisional application No. 63/592,047, filed on Oct. 20, 2023.

(51) Int. Cl. H04L 9/40

(52) U.S. Cl. CPC H04L 63/1425

(57) ABSTRACT

A method for reducing the risk of unexpected or unintended actions during a Remote Desktop Protocol (RDP) or SSH (Secure Shell) session by automatically detecting anomalies using vaulted credentials. The method includes initiating a RDP/SSH session on a server and taking screenshots of the session. The screenshots are sent to a system that uses a computer vision algorithm to transcribe the screen information into a text-based transcription of the session. The text-based transcription of the session recording is then provided to a pre-trained LLM which is prompted to look for anomalies using in-context learning. The detected anomalies are presented to a system administrator or sent as alerts to the system administrator.

### FIELD OF THE INVENTION

This invention relates to the field of system administration and cybersecurity. More specifically, it pertains to a novel tool that enhances security by enabling system administrators to securely remote into a server via Remote Desktop Protocol (RDP) or SSH using vaulted credentials, while simultaneously monitoring the session in real-time using a computer vision algorithm and AI for anomaly detection.

### BACKGROUND OF THE INVENTION

Remote Desktop Protocol (RDP) is a proprietary protocol developed by Microsoft® that allows users to connect to another computer over a network. It provides a graphical interface to the user for connecting to another computer remotely, facilitating tasks like remote administration and technical support. SSH (Secure Shell) is a cryptographic network protocol used for secure communication over an unsecured network. It provides a secure channel for remote login and command execution on servers, typically using public and private key pairs for authentication. SSH is commonly used for managing Linux servers. For security, it is possible to use vaulted credentials with RDP or SSH. Vaulting credentials involves securely storing sensitive information like usernames and passwords in a credential vault. These vaults are designed to protect credentials from unauthorized access and misuse. When using vaulted credentials with RDP/SSH, the process typically involves:
Secure Storage: Credentials are stored in an encrypted vault, accessible only to authorized users or applications.
Access Control: Users authenticate to the vault using multi-factor authentication (MFA) or other secure methods to retrieve credentials.
Session Initiation: Once authenticated, the user retrieves the necessary credentials from the vault, often through an automated process, to initiate an RDP/SSH session without exposing the credentials to the user directly.

In order to monitor the RDP/SSH session in real-time, a computer vision algorithm for anomaly detection can be used. Implementing a computer vision algorithm involves capturing the RDP/SSH session screen in real-time. This can be achieved by continuously taking screenshots or video frames of the session. For anomaly detection, the core idea is to use computer vision techniques to analyze the visual content of these frames to detect unusual activities or anomalies. This could include detecting deviations from normal user behavior, such as unexpected mouse movements or keyboard inputs, identifying screen content that indicates unauthorized access, like unfamiliar applications being opened, and recognizing security threats such as visual indicators of malware or phishing attempts or error messages.

Implementation steps include:
Data Collection: Continuously capture frames from the RDP/SSH session.
Preprocessing: Enhance and prepare the captured frames for analysis, which might involve noise reduction and normalization.
Feature Extraction: Use computer vision techniques to extract relevant features from the frames that might indicate anomalies.
Model Training: Fine-tune trained machine learning models on labeled data to recognize normal versus anomalous behavior.
Real-time Analysis: Deploy the trained model to analyze frames in real-time, flagging any detected anomalies for further investigation.

However, monitoring a RDP/SSH session in real-time for anomaly detection presents challenges and considerations such as performance by seeking to ensure that the monitoring does not degrade the performance of the RDP/SSH session, maintaining user privacy while monitoring, ensuring data is handled according to privacy laws and regulations, and accuracy by balancing false positives and false negatives in the anomaly detection to minimize unnecessary alerts while catching genuine threats.

### SUMMARY OF THE INVENTION

Although by integrating vaulted credentials with real-time monitoring using computer vision, organizations can enhance the security of RDP/SSH sessions, ensuring that credentials are securely managed and any unusual activities during the session are swiftly detected and addressed, the present invention uses techniques to do so in a manner which minimizes the above noted challenges and considerations.

The invention, referred to as Artificial Intelligence Driven Audit (AIDA) provides an advanced system for secure remote administration of servers. As described above, using encrypted vaulted credentials, a system administrator can gain remote access to a server using RDP/SSH. The vaulting system ensures that login credentials are securely stored and managed, thereby reducing the risk of unauthorized access. While the system administrator is logged in, the session is monitored in real-time. Screenshots of the active session are sent to a computer vision algorithm, which transcribes the activities happening in the session. This transcription is then processed by a Large Language Model (LLM) such as one known as Generative Pretrained Transformer (GPT) with a specific prompt, such as: “You are a security analyst, analyzing OCR output of live remote sessions. Your task is to determine if anything anomalous or suspicious is happening during the remote session.” The LLM which is an artificial intelligence (AI), is trained and/or fine-tuned to identify patterns and anomalies, review the transcription and check for any activities that deviate from the norm. Any suspicious or anomalous activities are timestamped and flagged for further investigation. This level of scrutiny allows for immediate detection and swift action in case of any potential security breach.

### BRIEF DESCRIPTION OF THE DRAWINGS

FIG. 1 is a flow diagram illustrating the steps performed by the invention.

FIG. 2 is a functional block diagram showing connections between the various system elements of the invention.

### DETAILED DESCRIPTION OF THE INVENTION

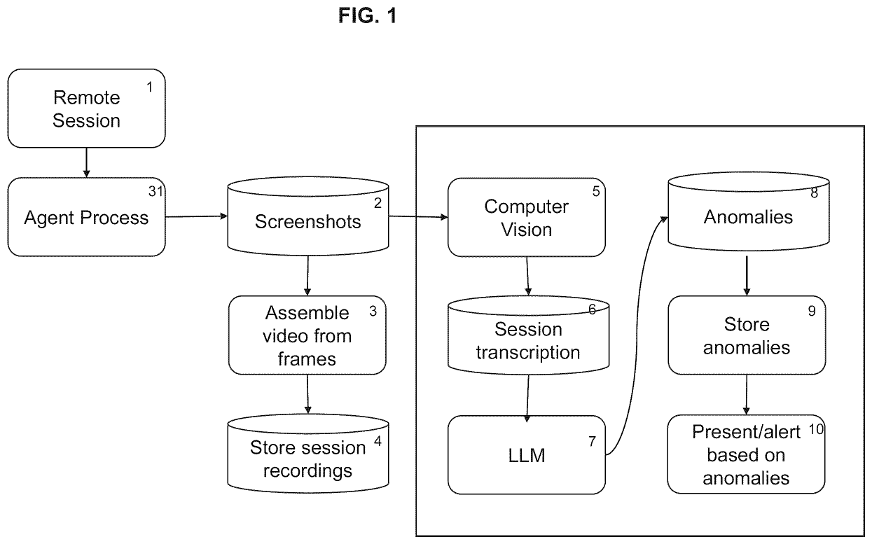

With reference to FIG. 1, the invention includes the following elements:
1. As RDP/SSH session 1 is initiated on a server/remote computer 22.
2. Screenshots 2 of the session are made by management agent software (agent process 31) such as an agent configured to create screenshots for assembling into a video of the remote session. Such software agents are well known to persons having ordinary skill in the art and, therefore, need not be further described herein.
3. These screenshots are used to assemble 3 a session recording video.
4. The session recording video is stored 4 so it can be viewed by a system administrator.
5. The screenshots are also sent to a system that uses a computer vision algorithm 5 to transcribe the screen information into text. Computer vision algorithms are well known to persons having ordinary skill in the art and, therefore, need not be further described herein. Normally, the output of such computer vision algorithm is a cleaned-up image which can be used to identify object types, their position in the image and the like. However, the invention takes a further step of extracting text from the image so that the text of the RDP/SSH session is recreated.
6. This results in a text transcription 6 of the session.
7. This session transcription is used to do a request to a LLM system 7 fine-tuned to find any activity that is out of the ordinary using a prompt of the type noted above,
8. The LLM request outputs 8 any detected anomalies based on its fine-tuned training.
9. The anomalies are stored 9.
10. The stored anomalies are presented 10 to the system administrator or sent as alerts.

In the prior art, would normally be, if using AI, to send a recording from a computer vision algorithm directly to an AI for analysis, but technical limitations make this approach untenable.

However, unlike the prior art, the invention lies in not sending the video recording of an administrative remote session directly to an AI for processing and checking for anomalies, but by breaking this down into:
1. Create a transcription, using machine vision on session recording to perform optical character recognition (OCR) to obtain text.
2. Feed the text transcription of the session recording into a pre-trained LLM.
3. Prompt the LLM to look for and report anomalies using in-context learning

The LLM is fine-tuned by presenting appropriate prompts to the LLM.

By way of example, the following prompts could be provided to the LLM:
You are a security analyst, analyzing OCR output of recorded remote sessions.
Your task is to determine if anything anomalous or suspicious happened during a recorded remote session.
Regard any authentication failure messages as suspicious.
Regard any privileges failure messages as suspicious.
Regard any text that indicates that something was deleted as anomalous.
Regard any text that indicates that something was downloaded as anomalous.
Return a separate json object for each anomaly you find in the transcript. Each anomaly should include the following properties:
   Timestamp: timestamp the anomaly occurred
   Message: text that you think is anomalous
   Explanation: explanation of why you think this action is anomalous

These prompts can be adjusted to fine tune an LLM as necessary to detect suspicious and anomalous activities. That is, the pretraining of the LLM can be expanded to cover additional activities that should be considered suspicious or anomalous. For example, the pretraining can also cover any TTPs that are in other security research resources such as MITRE ATT&CK or Metasploit repositories.

Further optimizations can be performed, like frame deduplication and noise reduction to further improve efficiency. Also, the transcription is not limited to just recognizing text from the screen captures, but can also include recording keystrokes and interpreting what the user is doing from the screen recording or other system level information about running processes, etc. The prompt for in-context-learning could also include an IT ticket for more context on what the purpose was of the administrative remote session.

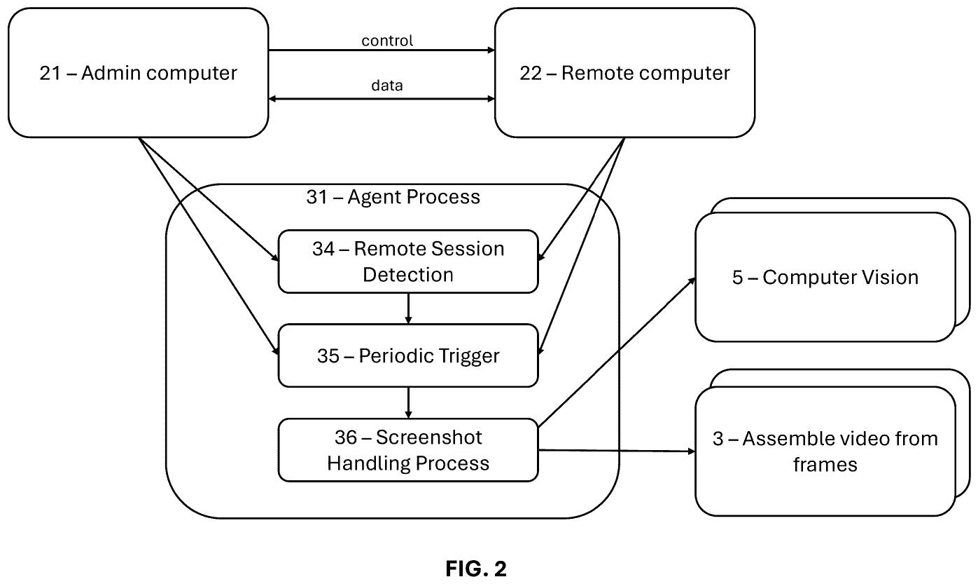

With reference to FIG. 2, the function block elements of the invention are the computer 21 from which an administrator initiates an RDP/SSH session, the desktop or server computer 22 being controlled by the RDP/SSH session, the agent process 31 which takes and assembles the video from frames, which can run on computer 21 or 22 and provides remote session detection from remote computer 22. Computer 21 or computer 22 then causes the agent to produce a periodic trigger 35 which in turn causes screenshot handling process 36 to capture screenshots from remote computer 22 which are used: to assemble 3 video from frames and as input for the computer vision process 5. As FIG. 1 shows, after assembly of the video from the frames, the session recording is stored 4. Also, FIG. 1 shows that after the computer vision 5, the other steps of shown in FIG. 1 take place.

This invention offers several benefits. It also provides real-time monitoring of sessions, which could be critical in identifying and addressing potential security threats. Moreover, the use of AI helps in more accurately identifying anomalies, thereby reducing the chances of false alarms.

The invention can be implemented in various environments where secure remote server administration is required. It is particularly useful for organizations handling sensitive data, such as financial institutions, government agencies, and healthcare providers. It is also possible to integrate the system with other security tools and expand its applicability to other remote access protocols. In summary, the invention provides a novel solution for secure remote system administration by reducing the risk of anything unexpected or unintended happening during the session by automatically detecting anomalies.

The flow and block diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram.

Moreover, not all acts illustrated in a methodology may be required for a novel implementation.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method for reducing the risk of unexpected or unintended actions during a Remote Desktop Protocol (RDP) or SSH (Secure Shell) session by automatically detecting anomalies using vaulted credentials comprising:
initiating a RDP/SSH session on a server;
taking screenshots of the session;
sending the screenshots to a system that uses a computer vision algorithm to transcribe the screen information into a text-based transcription of the session;
providing the text-based transcription of the session recording into a pre-trained LLM which has been fine-tuned to detect anomalies in the text;
prompting the LLM to look for anomalies in the text-based transcription using in-context learning;
the LLM outputting detected anomalies based on its training and fine tuning;
presenting the anomalies to a system administrator or sending the anomalies as alerts to the system administrator.

2. The method defined by claim 1 wherein said computer vision algorithm uses optical character recognition (OCR) on the screen information to obtain a text-based transcription of the session, the method further comprising prompting the LLM to look for and report the anomalies in the text-based transcription using in-context learning.

3. The method defined by claim 1 wherein the pre-trained LLM detects anomalies in the text-based transcription if there is any of an authentication failure message, a privilege failure messages, a deletion of any text in the transcription, any text indicating a download

4. The method defined by claim 3 further comprising returning a separate json object for each anomaly detected in the text-based transcription.

5. The method defined by claim 4 wherein each anomaly includes a timestamp indicating when the anomaly occurred, the text of the anomaly and an explanation of why the LLM determined that there was an anomaly.

6. The method defined by claim 1 further comprising performing frame deduplication and noise reduction on the screenshots before sending them to the system that uses the computer vision algorithm.

7. The method defined by claim 1 wherein the transcription includes recording keystrokes for a purpose of interpreting what the user is doing from the screenshots.

8. A system for reducing the risk of unexpected or unintended actions during a Remote Desktop Protocol (RDP) or SSH (Secure Shell) session by automatically detecting anomalies using vaulted credentials comprising:
a computer from which an administrator initiates an RDP/SSH session,
a second computer for being controlled by the RDP/SSH session
an agent process which takes and assembles video from frames recorded during said Remote Desktop Protocol (RDP) or SSH (Secure Shell) session and provides remote session detection which causes the agent to produce a periodic trigger to initiate a screenshot handling process to capture screenshots from the second computer and assemble the video from said frames;
a computer vision process which receives said video and transcribes the screenshots into a text-based transcription of the session;
a pre-trained LLM which receives the text-based transcription and is fine-tuned to detect anomalies in the text-based transcription;
wherein the detected anomalies are presented to a system administrator.

9. The system defined by claim 8 wherein said computer vision algorithm uses optical character recognition (OCR) on the screen information to obtain a text-based transcription of the session, and the LLM is prompted to look for and report the anomalies in the text-based transcription using in-context learning.

10. The system defined by claim 8 wherein the pre-trained LLM detects anomalies in the text-based transcription if there is any of an authentication failure message, a privilege failure messages, a deletion of any text in the transcription, any text indicating a download

11. The system defined by claim 10 wherein the system returns a separate json object for each anomaly detected in the text-based transcription.

12. The system defined by claim 11 wherein each anomaly includes a timestamp indicating when the anomaly occurred, the text of the anomaly and an explanation of why the LLM determined that there was an anomaly.

13. The system defined by claim 8 wherein frame deduplication and noise reduction on the screenshots are obtained before sending them to the system that uses the computer vision algorithm.

14. The system defined by claim 8 wherein the transcription includes recorded keystrokes for a purpose of interpreting what the user is doing from the screenshots.
